(19) United States
(12) Patent Application Publication
(10) Pub. No.: US 2009/0032705 A1
(43) Pub. Date: Feb. 5, 2009

(54) Fast Tip Scanning For Scanning Probe Microscope

(76) Inventors: Dale W. Schroeder, Scotts Valley, CA (US); George M. Clifford, JR., Los Altos Hills, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/831,672

(22) Filed: Jul. 31, 2007

(51) Int. Cl. G01N 23/00

(52) U.S. Cl. 250/307; 250/306

(57) ABSTRACT

An atomic force microscope apparatus scans a sample disposed in an X-Y plane, the sample having a surface, the surface having features in a Z direction perpendicular to the X-Y plane. The apparatus comprises an elongated arm having a pivot point and being rotatable about the pivot point in the X-Y plane; and a probe tip substructure that includes (i) a probe tip and (ii) a tip actuator. The probe tip substructure is disposed on the elongated arm a predetermined distance from the pivot point, wherein the arm disposes the probe tip at a location extended outward from the remainder of the AFM apparatus. The atomic force microscope apparatus moves the probe tip (i) by rotating the elongated arm about the pivot point, and (ii) by moving the tip actuator.

### BACKGROUND OF THE INVENTION

The invention relates to atomic force microscopy, and to atomic force microscope (AFM) instruments. An atomic force microscope is a very high-resolution type of scanning probe microscope. The AFM, invented by Binnig, Quate and Gerber in 1986, is one of the foremost tools for imaging, measuring and manipulating matter at the nanoscale. A conventional AFM comprises a microscale cantilever with a sharp tip (probe) at its end.

A specimen (herein also called “sample”) is typically characterized in terms of a surface area, delineated by dimensions in X and Y directions (conventionally treated as two orthogonal horizontal directions), that is, an X-Y domain. Over the surface area, the surface of the specimen has features or artifacts that cause variance in a Z direction, orthogonal to the Z and Y directions and conventionally treated as vertical.

Scanning the specimen with the AFM essentially involves determining the Z values for points or lines across the X-Y area of the specimen. The points or lines cover the X-Y domain to within a desired resolution. The scan is performed by moving the tip across the specimen to identify the Z value for given X-Y points or lines. AN AFM apparatus moves the cantilever, thereby moving the tip to the X-Y coordinates to be scanned. Additionally, AFM equipment can manipulate the surface of the specimen, and change the Z value at desired portions of the specimen by depositing material, etc.

### SUMMARY OF THE INVENTION

An atomic force microscope apparatus scans a sample disposed in an X-Y plane, the sample having a surface, the surface having features in a Z direction perpendicular to the X-Y plane. The apparatus comprises an elongated arm having a pivot point and being rotatable about the pivot point in the X-Y plane; and a probe tip substructure that includes (i) a probe tip and (ii) a tip actuator. The probe tip substructure is disposed on the elongated arm a predetermined distance from the pivot point, wherein the arm disposes the probe tip at a location extended outward from the remainder of the AFM apparatus. The atomic force microscope apparatus moves the probe tip (i) by rotating the elongated arm about the pivot point, and (ii) by moving the tip actuator.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a system block diagram of a prior art atomic force microscope (AFM) system.

FIG. 2 is a diagram of an apparatus according to an embodiment of the invention.

FIG. 3 is a diagram of an apparatus according to an embodiment of the invention.

FIG. 4 is a diagram of an apparatus according to an embodiment of the invention.

FIG. 5 is a diagram of an apparatus according to an embodiment of the invention.

FIG. 6 is a diagram of an apparatus according to an embodiment of the invention.

FIG. 7 is a diagram of an apparatus according to an embodiment of the invention.

FIG. 8 is a diagram of an apparatus according to an embodiment of the invention.

FIG. 9 is a diagram of an apparatus according to an embodiment of the invention.

### DETAILED DESCRIPTION

A conventional AFM comprises a piezoelectric stack having a cantilever with a sharp tip (probe) at its end. The cantilever is typically fabricated of silicon or silicon nitride with a tip radius of curvature on the order of nanometers. The tip is used to scan the specimen surface. Through manipulation of the cantilever by applying voltage to the stack, the tip is brought into proximity of a sample surface.

The cantilever is mechanically coupled to a mechanism for moving the cantilever in the X-Y direction to scan the surface of the sample, and in the Z direction as the tip scans the surface of the sample. The moving mechanism may include a piezoelectric structure, such as a stack of piezoelectric layers. When a suitable electric field is applied, the piezo layers change dimensions, and the cumulative dimensional changes cause the cantilever to deflect correspondingly. Note, however, that the cantilever deflection is with respect to the sample. The cantilever generally does not move or bend, relative to the piezo stack. Rather, the piezo stack carries the cantilever such that the cantilever maintains a constant deflection.

In the discussion that follows, the references to the X, Y, and Z directions are intended, broadly and without limitation, to refer to orthogonal or generally orthogonal (e.g., perpendicular) dimensions regarding a sample, its surface, and features thereon. For purposes of example, it may be understood that the sample is oriented such that its X and Y dimensions define a horizontal plane, and its surface features, artifacts, etc., are in the Z direction, for instance as a function of (X,Y) coordinates of the plane of the sample surface. However, this understanding as to specific examples in no way limits the scope of embodiments of the invention.

The scan of the surface of the sample is measured, for instance, by employing a laser which is reflected from the surface of the cantilever into an array of photodiodes. However a laser detection system can be expensive and bulky. Other methods that are used include optical interferometry, capacitive sensing or piezoresistive AFM probes. For instance, these probes are fabricated with piezoresistive elements that act as a strain gauge. Using a Wheatstone bridge, strain in the AFM probe due to deflection can be measured, but this method is not as sensitive as laser deflection or interferometry.

If the tip scanned the sample at a constant height, there would be a risk that the tip would collide with the surface, causing damage to the probe, as well as to the sample. Hence, in most cases a feedback mechanism is employed to adjust the tip-to-sample distance to maintain a constant force between the tip and the sample. Conventionally, the sample is mounted on a piezoelectric tube that can move the sample in the Z direction for maintaining a constant force, and the X and Y directions for scanning the sample. Alternately a ‘tripod’ configuration of three piezo crystals may be employed, with each responsible for scanning in the X, Y and Z directions. This eliminates some of the distortion effects seen with a tube scanner.

The sample is scanned by running the probe across the sample's surface along a designated path, for instance a back-and-forth path analogous to a television raster or in concentric curves according to a polar coordinate system, etc., to cover the sample surface to within a desired resolution. The raster-type movement of the sensor may be accomplished by movement of the sensor, movement of the sample, or a combination of both. The resulting map of S(X,Y) represents the topography of the sample, where the function S is the Z dimension of the sample for a given set of points X, Y (such as the raster path within the X-Y domain) on the sample surface.

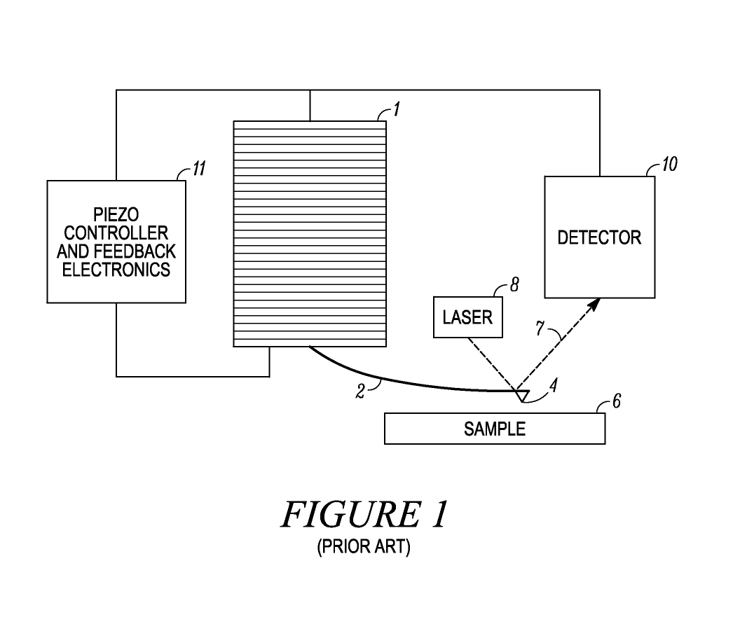

### FIG. 1

### A CONVENTIONAL AFM

FIG. 1 is a diagram of such a typical AFM apparatus. A cantilever 2 has a sensor member such as a probe tip 4. The tip 4 is used to scan the surface of a specimen 6 for variations in the specimen 6's Z-dimension variations, as a function of X and Y.

Offsetting the cantilever 2 in the Z direction is performed, conventionally, by a piezoelectric structure 1, made up of numerous layers disposed in a stack oriented in the Z direction. Electric fields, applied to the piezoelectric stack 1, cause the Z dimension of the stack 1 to vary. A laser 8 directs a beam to the tip 4, and the beam is reflected to a detector 10. The detector generates a signal indicative of movement of the tip 4. That signal is provided to a piezo controller 11, which employs the signal as feedback for controlling the electric field applied to the piezo stack 1 to cause it to operate.

The cantilever 2, mounted on one end of the stack 1, is deflected correspondingly with the variance of the Z dimension of the stack 1. It is the case, then, that the Z-direction orientation of the cantilever 2 is actuated to remain constant, relative to the piezo stack 1. Furthermore, the range of Z movement of the tip 4, and its speed of responsiveness to changes in the Z contour of the sample 6, are limited by the responsiveness of the piezo stack 1 to the electric field applied to it by the controller 11.

Another important consideration with such prior art AFM apparatus, is that the size and configuration of the apparatus, particularly that of the piezo stack 1, limits how the apparatus can be used. Generally, a sample for AFM scanning must be flat, and must fit within a small space adjacent to (for instance, beneath) the cantilever 2. This requirement has disadvantageously limited the ways in which such conventional AFM apparatus may be used.

An AFM apparatus employs mechanical actuators, etc., such as a fast nano-stepper (not shown), to move the tip 4 in the Z direction. An example of such nano-stepping apparatus is described in Hoen et al., U.S. Pat. No. 5,986,381, “Electrostatic Actuator with Spatially Alternating Voltage Patterns.”

If the tip 4 were to scan the sample 6 at a constant height, then there would be a risk that the tip 4 would collide with the surface of the sample 6, causing damage. Hence, in most cases a feedback mechanism is employed to adjust the tip-to-sample distance to maintain a constant force between the tip 4 and the sample 6. Conventionally, the sample 6 is mounted on a Z-dimension movable member, such as a piezoelectric tube, that can move the sample in the z direction for maintaining a constant force. Similar structures for the x and y directions may also be used, to facilitate scanning the sample 6. Alternately a ‘tripod’ configuration of three piezo crystals may be employed, with each responsible for scanning in the x, y and z directions. This eliminates some of the distortion effects seen with a tube scanner.

Typically, the deflection of the cantilever 2 is measured using a laser beam 7 from a laser light source 8, reflected from the top of the cantilever 2, or from the tip 4, into a detector 10, here shown as an array of photodiodes. Other methods that are used include optical interferometry, capacitive sensing or piezoresistive AFM probes. These probes are fabricated with piezoresistive elements that act as a strain gauge. Using circuitry or other apparatus, for instance a Wheatstone bridge, strain in the AFM probe due to deflection can be measured, but this method is not as sensitive as laser deflection or interferometry.

The AFM thus provides a true three-dimensional surface profile. Samples viewed by AFM do not require any special treatments (such as metal/carbon coatings) that would irreversibly change or damage the sample. Most AFM modes work well in ambient air or even a liquid environment. This makes it possible to study biological macromolecules and even living organisms.

Traditionally the AFM requires several minutes for a typical scan (that is, one raster line across a sample). The relatively slow rate of scanning during AFM imaging often leads to thermal drift in the image, making the AFM microscope less suited for measuring accurate distances between artifacts on the image. AFM images may be affected by hysteresis of the piezoelectric material and cross-talk between the (X,Y,Z) axes such that they require software enhancement and filtering in order to be meaningful. Such filtering is time-consuming and often “flattens” out real topographical features.

One of the main challenges in AFM design is maximizing scanning speed. Because of the mechanical complexity of controlling the separate X- and Y-dimension movement of the tip 4 on the cantilever 2, it can take many hours to capture a complete picture of a specimen of typical X and Y dimensions.

Increasing the rise and fall speed of the tip 4 (Z direction) is only part of the solution. The sample or the tip 4 also has to move at high speed in the X and/or Y directions. Moving the sample 6, as is ordinarily done with slow AFMs, limits sample size at high speed. Moving the tip 4 and Z actuator at high speed is also a problem, because the additional structure and circuitry must also be moved at high speeding at least X or Y. Included in this category are the fine Z actuator, the coarse Z actuator and the tip position sensor laser and receiver.

Finally, the conventional AFM apparatus (including a bulky piezo stack, etc., limits the uses of the apparatus. That is, the apparatus may not be used to scan the interior of an enclosed or concave structure because the apparatus cannot fit inside the structure, and the structure cannot be laid flat beneath the cantilever and piezo stack.

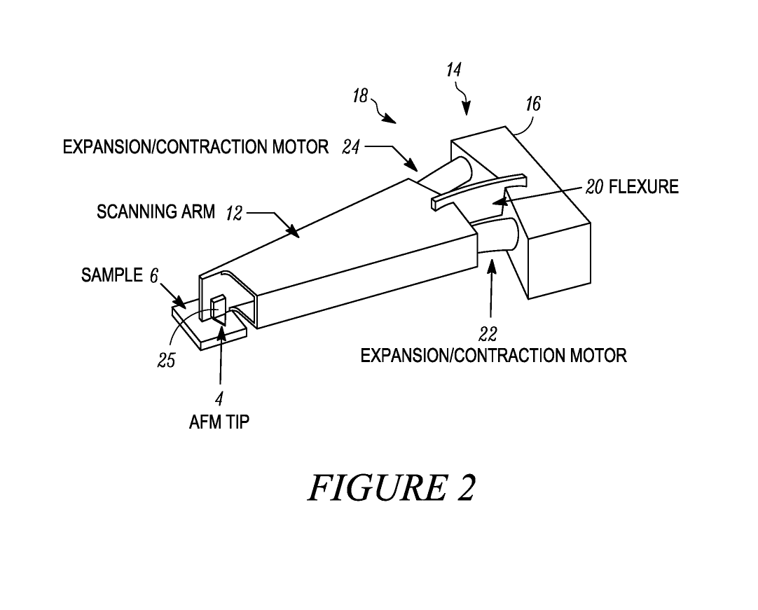

### FIG. 2

### AN EMBODIMENT OF THE INVENTION

An AFM apparatus embodying the invention is shown in FIG. 2. An AFM tip 4 and a sample 6 are generally as described above, and so are numbered correspondingly. Additionally, the apparatus comprises an elongated member shown as a scanning arm 12. At a predetermined location on the scanning arm 12, there is a pivot point 14, shown as a structure about which the scanning arm 12 may move. The pivot point 14, in an embodiment of the invention, is located at a first predetermined position on the scanning arm 12, such as at a first end thereof. The tip 4 is located at a second predetermined position on the scanning arm 12, such as at a second end thereof. In an embodiment of the invention, the scanning arm 12 disposes the tip 4 at a location extended outward from the remainder of the AFM apparatus, so that the sample 6 need not be minimized in shape, mounting, etc., to be inserted within the AFM apparatus. This is in contrast to a conventional AFM apparatus (described above), in which structures such as the piezoelectric stack 1 of FIG. 1 are configured such that the tip 4 is within an enclosed AFM apparatus structure, requiring that the sample be kept small enough to be inserted therewithin.

The pivot point 14 may include an anchoring structure which permits angular movement, within a given range of movement, of the scanning arm 12 about the pivot point 14. In the embodiment of FIG. 2, the pivot point 14 includes an anchoring structure 16, and an angular movement mechanism 18. The angular movement mechanism 18 here includes a flexure member 20, and first and second expansion/contraction motors 22 and 24.

In addition to the angular movement mechanism 18, the tip 4 is also moved by a tip actuator, shown as a motor 25. As shown, the motor 25 may be mounted, along with the tip 4, at or near the second predetermined position on the scanning arm 12. The motor 25 provides for additional motion of the tip 4, such as motion with additional degrees of freedom. For instance, if the scanning arm 12 moves angularly in the X-Y plane, the motor 25 may move the tip 4 in the Z direction. Together, the tip 4 and the tip actuator (e.g., the motor 25) make up a tip substructure. Additional embodiments of probe tip substructures may include other configurations, types of actuators, etc., which provide one or more degrees of freedom of movement for the tip 4, in addition to the motion of the tip 4 afforded by movement of the scanning arm 12.

An AFM apparatus thus embodying the invention increases speed, and thereby shortens total scan times, by simplifying the mechanics of the movement of the tip 4 across the specimen 6. Such an apparatus includes a structure for moving the tip over the sample in a radial path by rotating the scanning arm 12 about the pivot point 14. Thus, an embodiment of the invention may combine such a radial scanning structure with a fast nano-stepper 25.

Such an embodiment of the invention moves the tip, for instance, in a curved path about the pivot point 14. This allows a very low mass arm to quickly move the tip back and forth, thereby quickly scanning the area to be imaged.

In an embodiment of the invention, the tip moves according to a predetermined path, which may for instance be a curve, a straight line, etc. In different embodiments of the invention in which the tip movement is curved, the curvature may be within a plane of curvature in respective different orientations with respect to the X-Y surface of the sample. In one embodiment, the plane of curvature is also in an X-Y plane, parallel to the X-Y plane of the sample. In another embodiment, the plane of curvature may be perpendicular to the X-Y plane of the sample. For instance, the plane of curvature may be in an X-Z plane. In such an embodiment, the path of the tip may be thought of as resembling the path of a pendulum, suspended above the surface of the sample and passing back and forth over the sample surface. Where this tip movement is an arc or curved path, but the range of angular movement is small, to a good approximation the path of the tip 4 remains a constant Z-direction distance from the surface of the sample 6. This follows from the known principle that, for small angles, the sine of the angle may be approximated to equal the angle itself.

It is possible to add further control and flexibility as to the path of movement of the probe tip 4, by providing a mechanism that facilitates change of the distance between the pivot point 14 and the tip 4. This can be accomplished by a telescoping elongated arm, etc. Thus, if the rotation of the elongated arm about the pivot point 14 and the lengthening of the elongated member are both controlled, it is possible to define any desired path for the probe tip to follow, including, for instance, a straight line.

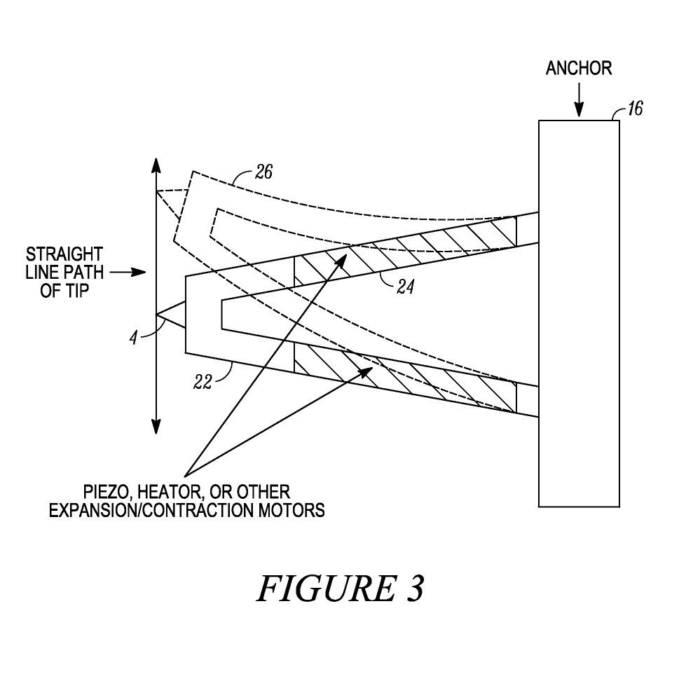

FIG. 3 shows additional details of the AFM apparatus of FIG. 2. The elongated member is shown as including a pair of elongated members 22 and 24 that are similarly oriented. Specifically, they are anchored at two points on the anchoring structure 16, and project in similar directions, so as to converge. The members 22 and 24 meet at a convergent position, here shown as the opposite ends of the members 22 and 24, which bears the probe tip 4.

In the embodiment of FIG. 3, the members 22 and 24 flex cooperatively, as shown by a dotted-line deflection image 26. To enable the flexing, the members 22 and 24 have suitable structural features, such as piezoelectric material, differential coefficients of thermal expansion, etc. Suitable additional components such as heaters/coolers, electric field generators, motors, etc., (not shown) are also provided. Due to the various possible mechanisms for such flexing, it is also possible that the length of the members 22 and 24 may change, as well.

The cooperative flexing of the members 22 and 24, and/or their changes in length, cause the probe tip 4 to move in a path that is characteristic of their respective flexing and lengthening. This path is not necessarily circular, as would be the case with the previously described embodiment. Rather, in the embodiment of FIG. 3 the probe tip's path is, or more closely approximates, a straight line, as shown.

As before, such movement is within the X-Y plane, and a Z-direction deflection is produced as the probe tip 4 moves over the sample. Suitable approaches to monitoring such Z-direction deflection, such as the laser reflection described above, is used.

The laser, sensor and other parts can be mounted at a pivot point near the points where the members 22 and 24 are affixed to the anchoring structure 16. At such location, they are subject to only a small angular acceleration.

As described in connection with the above-discussed embodiments of the invention, depending on the length of the elongated member, relative to the dimensions of the sample, the length of the arc may be short enough that it can be approximated to a straight line.

For example: Consider a sample having an area of 40 um×40 um, which is to be scanned at 200 nm resolution. It gives an image of 200×200 pixels. To scan 40 um, an arm 50 mm long from pivot to tip turns only 14×10-6 degrees, and the deviation from a straight line is only +−2 nm or 0.01 of the line spacing.

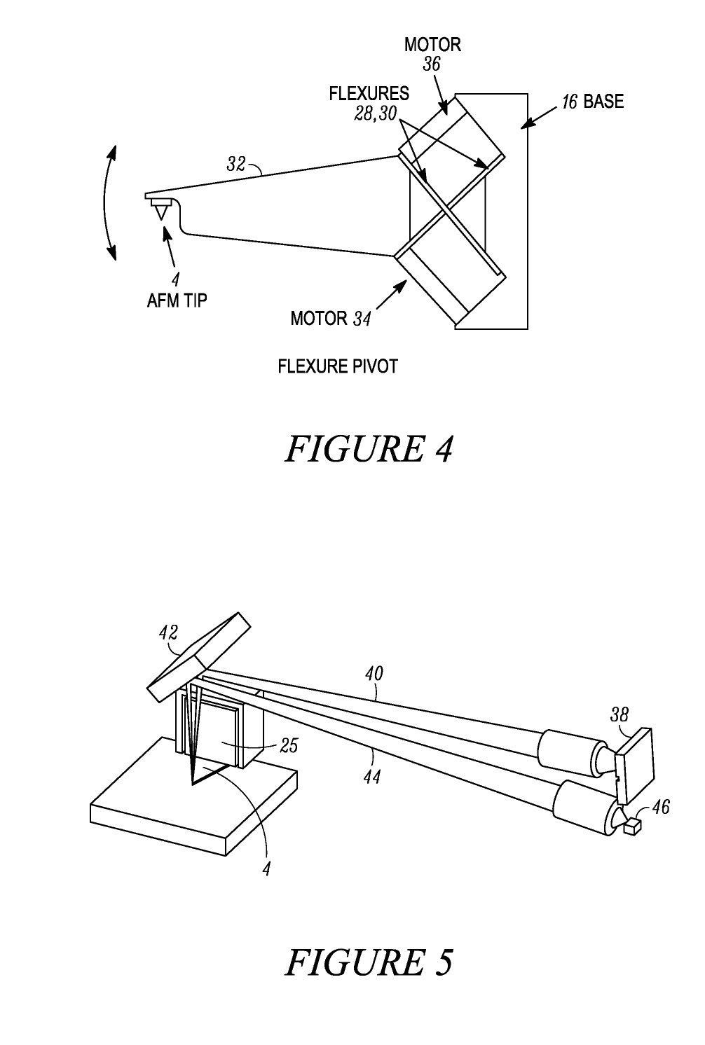

### FIGS. 4-9

### ADDITIONAL EMBODIMENTS

FIG. 4 is a diagram of another embodiment of the invention. Flexure members 28 and 30 are coupled between the anchoring structure 16 and a scanning arm 32. Specifically, the flexure members 28 and 30 are coupled to the scanning arm 32 at complementary points, such that complementary manipulation of the flexure members 28 and 30 provide controlled angular movement of the scanning arm 32, to move the tip 4 over the sample (not shown). Actuators, shown as motors 34 and 36, impel the complementary manipulation of the flexure members 28 and 30.

FIG. 5 is a diagram of a laser subsystem for use in an embodiment of the invention. A laser light source 38 produces a coherent beam 40. Optics, shown as a reflector 42, direct the beam onto the tip 4. The beam is reflected off the tip 4, as per the movement of the tip 4 over the sample (not shown). The optics direct the reflected beam 44 to a sensor 46, which produces a receive signal as per the movement of the tip 4.

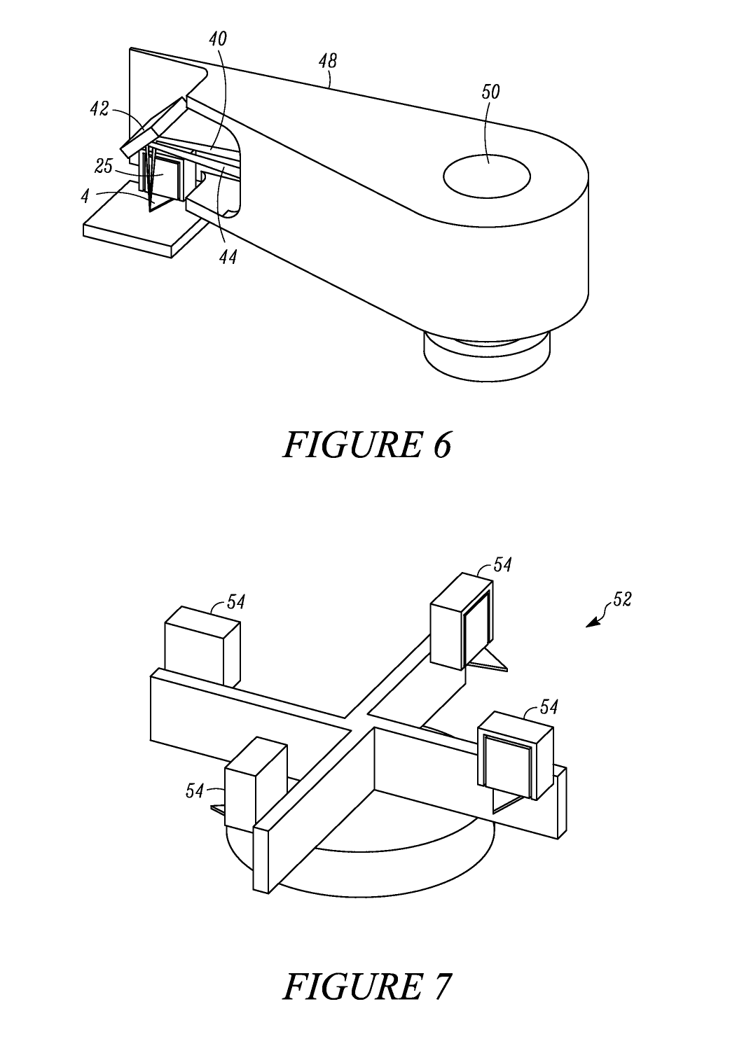

FIG. 6 is a partially cutaway diagram of another embodiment of the invention, incorporating the laser subsystem of FIG. 5. A housing 48 encloses the laser subsystem. In the illustrated embodiment, the housing 48 also encloses the entire pathway of the beam 40, 44. An rotary bearing assembly axle assembly 50 encloses the pivot point 14 (not shown).

The embodiment of FIG. 6 may be employed with a tip replacement apparatus, shown in FIG. 7. The tip replacement apparatus includes a magazine for holding multiple tips, and for mechanically interfacing with the embodiment of FIG. 6. The magazine may have various implementations for holding the tips in a suitable array, etc. In the embodiment of FIG. 7, the magazine is shown as a turntable holding a set of tip substructures 54, in this example each tip substructure 54 including a tip 4 and a tip actuator (e.g., a motor 25), as described above. The embodiment of FIG. 6 is disposed in proximity to the turntable 52, such as by rotating about the axle assembly 50. In operation, the embodiment decouples and drops off a tip substructure 54 to be replaced, the turntable 52 advances by rotating, and the embodiment then extracts and couples another tip substructure 54 from its position on the turntable 52.

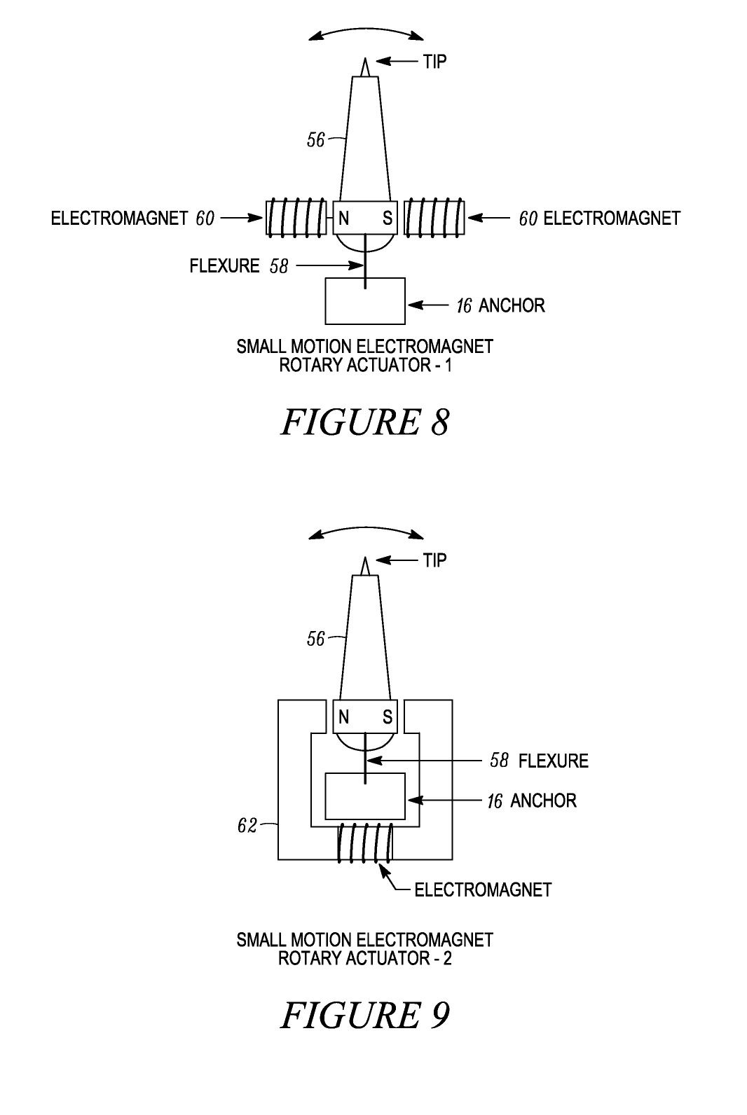

Additional embodiments are shown in FIGS. 8 and 9. In each case, the anchoring member 16 is coupled to a scanning arm 56, for instance by means of a single flexure member 58, although other coupling structures described above may also be used. In these embodiments, the scanning arm 56 is moved by means of an electromagnetic transducer, shown as a pair of oppositely-disposed electromagnets 60 in FIG. 8, and as a single horseshoe-type electromagnet 62 in FIG. 9. In either case, magnetic force from the electromagnets interacts with a magnetic member, such as a permanent magnet 64, disposed on the scanning arm 56 (as shown in both FIGS. 8 and 9).

In further embodiments of the invention, the apparatus may also include a sample moving subsystem, such as one or more servo motors coupled to a platform holding the sample, to move the sample in a way that complements the movement of the tip by the arm and the tip actuator, so as to result in a desired scanning path (e.g., a raster), for the tip across the sample.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. An atomic force microscope apparatus for scanning a sample disposed in an X-Y plane, the sample having a surface, the surface having features in a Z direction perpendicular to the X-Y plane, the apparatus comprising:
an elongated arm having a pivot point and being rotatable about the pivot point in the X-Y plane; and
a probe tip substructure that includes (i) a probe tip and (ii) a tip actuator, the probe tip substructure being disposed on the elongated arm a predetermined distance from the pivot point, wherein the arm disposes the probe tip at a location extended outward from the remainder of the AFM apparatus;
whereby the atomic force microscope apparatus moves the probe tip (i) by rotating the elongated arm about the pivot point, and (ii) by moving the tip actuator.

2. An apparatus as recited in claim 1, wherein
the elongated arm rotates about the pivot point in an X-Y plane; and
the tip actuator moves the tip in the Z direction.

3. An apparatus as recited in claim 1, wherein the probe tip moves in a path including concentric circular curves about the pivot point.

4. An apparatus as recited in claim 1, further comprising a lengthening apparatus for adjusting the distance between the probe tip and the pivot point.

5. An apparatus as recited in claim 4, wherein the elongated arm rotates about the pivot point and the lengthening apparatus adjusts the distance between the probe tip and the pivot point, such that the probe tip follows a predetermined path.

6. An apparatus as recited in claim 5, such that the predetermined path includes a straight line.

7. An apparatus as recited in claim 1, further comprising a sample moving subsystem for moving the sample in a way that complements the movement of the tip by the arm and the tip actuator, whereby a desired scanning path for the tip across the sample is achieved.

8. A method for operating an atomic force microscope (AFM) apparatus to scan a sample specimen disposed in an X-Y plane, the sample specimen having an area and features over the area in a Z direction perpendicular to the X-Y plane, to a predetermined resolution, the atomic force microscope apparatus having an elongated arm and a probe tip substructure mounted thereon, wherein the arm disposes the probe tip at a location extended outward from the remainder of the AFM apparatus, the probe tip substructure including a probe tip and a tip actuator, the method comprising:
rotating the elongated member to cause the probe tip to move across the sample specimen in an X-Y plane;
operating the tip actuator to move the tip relative to the Z direction; and
scanning a path across the sample specimen as the probe tip moves.

9. A method as recited in claim 8, wherein moving the probe tip across the sample specimen radially includes moving the probe tip on concentric circular curves about a pivot point.

10. A method as recited in claim 9, wherein the concentric circular curves are spaced about the pivot point so as to achieve the predetermined resolution in terms of a polar coordinate system having the pivot point as its origin.

11. A method as recited in claim 9, further comprising adjusting the distance between the probe tip and the pivot point, whereby the probe tip moves in a predetermined path.

12. A method as recited in claim 11, wherein the predetermined path includes a straight line.

13. A method as recited in claim 11, wherein the predetermined path includes a raster-type path.

14. An apparatus as recited in claim 8, further comprising moving the sample specimen in a way that complements the movement of the tip by the arm and the tip actuator, whereby the predetermined path for the tip across the sample specimen is achieved.

15. A method for operating an atomic force microscope (AFM) apparatus to scan a sample specimen disposed in an X-Y plane, the sample specimen having an area and features over the area in a Z direction perpendicular to the X-Y plane, to a predetermined resolution, the atomic force microscope apparatus having a probe tip substructure including a probe tip and a tip actuator, the probe tip substructure being disposed on an elongated arm that disposes the probe tip at a location extended outward from the remainder of the AFM apparatus, and that is rotatable about a pivot point which is a predetermined distance from the probe tip substructure, the method comprising:
rotating the elongated member about the pivot point, such that the probe tip moves across the sample specimen in an X-Y plane,
operating the tip actuator to move the tip relative to the Z direction; and
adjusting the distance between the pivot point and the probe tip, whereby the rotating and the adjusting cause the probe tip to move over the sample specimen according to a predetermined path.

16. A method as recited in claim 15, wherein the rotating, the operating, and the adjusting cause the tip to move over the sample specimen according to a predetermined path which includes concentric circular curves.

17. A method as recited in claim 15, wherein the rotating, the operating, and the adjusting cause the tip to move over the sample specimen according to a predetermined path which includes a straight line.

18. A method as recited in claim 15, wherein the rotating, the operating, and the adjusting cause the tip to move over the sample specimen according to a predetermined path which includes a raster-type path.

19. An apparatus as recited in claim 15, further comprising moving the sample specimen in a way that complements the movement of the tip by the arm and the tip actuator, whereby the predetermined path for the tip across the sample specimen is achieved.
